(19) United States
(12) Patent Application Publication
(10) Pub. No.: US 2017/0127245 A1
(43) Pub. Date: May 4, 2017

(54) 4G Drone Link

(71) Applicant: Timothy M Adkins, Beaufort, SC (US)

(72) Inventor: Timothy M Adkins, Beaufort, SC (US)

(21) Appl. No.: 14/931,803

(22) Filed: Nov. 3, 2015

(51) Int. Cl. H04W 4/04; G06Q 10/08; B64C 39/02

(52) U.S. Cl. CPC H04W 4/046; B64C 39/024; G06Q 10/0833

(57) ABSTRACT

A system and method are provided to support accommodating safe integration of small Unmanned Ariel systems (sUASs) or drones for the recognition of the ownership of the device. This high altitude cellular communications system platform utilizes a 4G/3G/1G data carrier with the standard cellular phone and an integrated circuit chip. The main advantage of the current invention is that it provides an airborne platform that has a CDMA/GSM/GPS receiver with a SIM card that can connect to a 4G/3G/1G carrier for tracking the owner of the drone. The device provided is a simple way to track ownership of a drone by adding a small receiver with the SIM card to a drone, so when the drone crash or go missing it would be traceable by pinging the 4g data link that has an IP address, just like we can ping a lost phone.

### CROSS REFERENCE TO RELATED APPLICATIONS

Not applicable.

### FEDERALLY SPONSORED RESEARCH & DEVELOPMENT

Not applicable.

### MICROFICHE APPENDIX

Not Applicable.

### BACKGROUND OF THE INVENTION

(1) Field of the Invention

The present invention relates to Unmanned Ariel systems (sUASs) or drones that are connected to a phone via a wireless connection that limits the distance the drone can fly. More particularly, the invention provides a system and method where a 4G drone link uses a standard cell phone carrier's 4g/3g/1g data and a SIM card to link a commercial drone or a store bought drone to its owner.

(2) Background of the Invention

Drones, such as unmanned aerial vehicles (UAVs), have been used by the military for various purposes. Recent legislation allows the domestic use of drones in particular air space in accordance with pending FAA regulations. Proposed domestic uses for drones tend to focus on law enforcement and other government functions.

Remotely controlled airborne unmanned drones are used for many purposes, including the testing and evaluation of weapons systems by various armed services. In particular, the military has found target drone formation flying to be significant in the evaluation of weapon systems. Certain control drone formation flying arrangements presently available utilize ground station computer control to maintain each aircraft's position in four dimensional spaces (XYZT). In the simplest example, with two airplanes flying in drone formation, the ground station would multilaterate or use triangulation to determine the position of each individual aircraft. The ground station independently triangulates the position of each aircraft. The disadvantage of this approach is that it takes a significant development to provide software in the ground stations for every new aircraft type that is to be adapted to this system. Accordingly, a system of this type is very expensive to develop and maintain. Perhaps more significantly, systems of this type are most appropriate for controlling complex drone formations flying on a grid system based range. A further disadvantage of this prior arrangement is that it is not effective when flying the drone formation outside of the range of the triangulation stations, which are necessary for the prior arrangement. This presents a clear disadvantage for flying drone formations over the oceans. It is even more difficult where the drone formations are over the horizon from the ground control stations.

A drone range tracking system is the means by which drones are tracked while traversing a range. It provides positional information to a drone controller. Two types of drone range tracking systems are currently in use, grid range and rho-theta. In a grid range system, the range is grid mapped. Ground relay stations are placed at surveyed points on the grid, and then drone command/telemetry time of arrival and trilateration are used to fix a drone's position in x, y, z coordinates.

Although the business of cellular communications has made great strides in the past 20 years, there are two areas where cellular carriers have not reached 100% capability: 1) 3G/4G coverage, and 2) secured communications. Regardless of the marketing, there are far more global locations with 2G coverages than any other, and the security of voice, text, camera, video, and other like communication has either had the encryption cracked, or the encryption is non-existent. This leaves gaping holes in robust global secured communications for organizations, which must have both high bandwidth and communications secured.

The Global Positioning System (GPS) is particularly useful for determining a position. Survival radios have been known to have GPS receivers capable of self-determinating their position. In a proposed next generation arrangement which is to permit flight of drones in formation and, in particular, is also directed toward providing over-the-horizon control capability, each drone will have a global positioning system (GPS) receiver. The GPS position from each drone is downlinked to a ground station or to a high flying aircraft. The GPS position is received and is used to control the flight of the drones to prevent collision. Again, a disadvantage of this type of arrangement is that the ground station will require a significant amount of software, along with the expense of developing such software. The one advantage of the GPS approach is that it will no longer be required to multilaterate.

U.S. Pat. No. 5,240,207 discloses a method to remotely pilot an air vehicle. A drone is a pilotless aircraft that is operated by remote control. Drones are used in many military applications as aerial targets, and for other purposes, such as reconnaissance.

U.S. Pat. No. 5,521,817 also discloses an autonomous airborne drone formation control system that is not dependent on the type of ground based control of the formation and which thereby permits operation at ranges having different equipment capabilities. A system in accordance with this invention has inter-range operability independent of the drone command and control ground stations.

It is desirable to provide a drone ownership recognition system that would be more independent of ground stations, and be independent of command/telemetry system types and aircraft types. It is further desirable to provide an automatic drone ownership recognition system that is independent of the particular drone range.

### SUMMARY OF THE INVENTION

Recognizing the deficiencies of prior methodologies, the present inventors have developed methods and systems for location-dependent provision of information to mobile devices, and, more particularly, secure connection between the drone and the 4G phone by adding CDMA/GSM/GPS receivers with a SIM card that could be connected to 4G/3G/1G carrier.

The present invention also provides a system with a small receiver that has an SIM to track ownership. The device uses mobile phone carriers 4G/3G/1G data and a SIM card to link a commercial drone to a store from which drone was bought.

This present invention presents a mechanism involving adding a CDMA/GSM/GPS receiver to a SIM card that could be connected to a 4G/3G/1G carrier. The 4G cloud is able to upload all cellular data controlled flights to an FAA database for instant telemetry of the flight.

As described above, the functional aspects of the current invention are connected to mobile phone via wireless G connection by a limitation of distance. For recognition of ownership, it is required to save it to a MAC and IP address. The current invention provides an airborne platform that has a CDMA/GSM/GPS receiver with a SIM card that can connect to a 4g/3g/1g carrier for tracking the owner of the drone. The drone could be tracked, code could be rewritten, and blackout areas could be added to a digital Map where the drone is giving a fault code and not lift off due to it being a drone black out area on the map, even if 4G is available and the drone is not be able to fly.

The device includes an altimeter, so that it is linked to a deployable reusable parachute should the drone decide to fall back to earth at terminal velocity. Furthermore, the speed, altitude, and position of the device update in real time. Altitude and distance thresholds could be set by writing the EPROM (Erasable Programmable Read-Only Memory). The drone owners could be mandated to upgrade to the 4G drone link before they fly.

OTA (Over the Air Updates) are sent daily to the drone via 4G cellular data for setting altitude and distance for drone novelist or flight path drone restrictions or drone black out map data. A navigation application is integrated into the drone widget by simply having the drone connected to a cellular 4/3/2 G cellular network. The widget could be accessed to provide the EPROM and start google maps/VZ navigation or whatever navigation Global positioning map is integrated on the cellular network and cellular phone.

The device is linked to a cellular service that is trackable on a map via the internet. Active drone Pins on map is display the owner's info by clicking on the drop pin. The information could include name, address phone number, time/date, and duration of flight. All information is accessible by law enforcement and the FAA.

The power supply for the device is a CMOS battery that could be added to keep the transponder/GPS locator active when the the drone looses power and or crashes. This will also be helpful to track rogue drone flights or active drones currently in the air.

Digital imaging and mapping could be uploaded to the 4G drone cloud, which could be viewed by law enforcement/FBI/CIA that is necessary to solve a case.

An advantage of the system is the secured information provided regarding the ownership of the drone to the administrator or user from the endpoint devices, which may include GPS location and more, via secured dedicated CDMA/GSM communications on both the status of the endpoint device and location thereof.

These and other systems, methods, objectives, features, and advantages of the present disclosure will be apparent to those skilled in the art from the following detailed description of the preferred embodiment and the drawings. All documents mentioned herein are hereby incorporated in their entirety by reference.

### DETAILED DESCRIPTION OF THE INVENTION

The following detailed description refers to the accompanying drawings, which illustrate the embodiments of the present invention. Other embodiments are possible, and modifications may be made to the embodiments without departing from the spirit and scope of the invention.

Therefore, the following detailed description is not meant to limit the invention. Rather, the scope of the invention is defined by the appended claims.

A drone, in a technological context, is an unmanned aircraft. Drones are more formally known as unmanned aerial vehicles (UAV). Essentially, a drone is a flying robot. The aircraft may be remotely controlled, or can fly autonomously through software-controlled flight plans in their embedded systems working in conjunction with GPS technology. UAVs have most often been associated with the military, but they are also used for search and rescue, surveillance, traffic monitoring, weather monitoring, and firefighting, among other things.

A SIM card, also known as a subscriber identity module, is a smart card that stores data for GSM cellular telephone subscribers. Such data includes user identity, location and phone number, network authorization data, personal security keys, contact lists, and stored text messages. Security features include authentication and encryption to protect data and prevent eavesdropping. Succeeding generations of mobile telecommunications technology includes 4G/3G/1G carriers, wherein 4G is the short name for fourth-generation wireless, the stage of broadband mobile communications that will supersede the third generation (3G). The Carrier 4G uploads all cellular data controlled flights to an FAA database for instant telemetry of the flight.

Disclosed in the present invention are methods and systems for location-dependent provision of information related to the unmanned aerial vehicle's ownership through a mobile device (e.g., a mobile phone, smart phone, tablet computer system or similar device). The information may be any information related to and broadcast by an entity, such as a service provider (e.g., a retail store).

The present disclosure describes an approach to resolve issues, such as when an unmanned aerial vehicle or drone is sold and there is no way to track it should it do damage to a low flying plane or crash. To overcome this issue, the provided device uses a standard mobile phone with carrier 4G/3G/1G and a SIM card to link a commercial drone to a store from which the device has bought. The device is connected to 4G clouds to map better drone shipping routes, collect data on cellular signals, and triangulate drone positions using cell towers. The drone is connected to 4G with a SIM (“Subscriber Identification Module”) card. The drone could be tracked and have its code be rewritten for blackout areas, then it could rewrite the code for altitude if it's being tracked on a 4G network, saved to the SIM.

Alternatively, or in addition to the methods and systems of the present invention, by addition of CDMA/GSM/GPS as a receiver the SIM card could be connected to a 4G/3G/1G carrier. This system provides a broader range with more secure connection between the unmanned aerial vehicle or drone and 4G phone.

In other instances, the 4G drone link is basically a stripped down cell phone that is capable of transmitting telemetry data back to the phone, or receiving data from the phone that is linked to the account via SIM, all controlled by an APP. It is also provided that speed, altitude, and position of the device are updated in real time. All flights will be saved to whatever cloud service has been chosen. Then the data could be accessed by the FAA via a database that is composed of cloud flight data to citations, fines, ground, or confiscate issues.

The method can further include the altitude and distance setting by writing the EPROM (Erasable Programmable Read-Only Memory). OTA (over the air updates) is sent to the drone via 4G cellular data to set altitude and distance for drone novelist, flight path drone restrictions, or drone black out map data. Every Navigation application is integrated to the device widget as well. Through the 4/3/2 G cellular network, the widget could be accessed to provide EPROM and start google maps/VZ navigation or whatever navigation Global positioning map is integrated on the cellular network and cellular phone. As long as the same application is loaded into the EPROM and on the cellular phone, communication is always constant. The Aircraft could be retrofitted with a transponder that sends out the same code as the, “drone black out zone” that is written into the EPROM. It could be transmitted at low, medium, or high power settings. Setting it to high power transmits the signal out in a 360 directional bubble out to a mile. The signal drops the device to a safe altitude or pushes it out of the bubble due to the drone being in a no fly zone. If the drone just fell out of the sky, then the parachute is deployed.

In the system of the illustrative embodiment, the device is linked to a cellular service that is trackable on a map via the internet. Active device pins on map will display the owner's info by clicking on the drop pin itself, such as information regarding name, address, phone number, time/date, and duration of flight. All information is accessible by law enforcement and the FAA.

Black out Map data and other restrictions, such as altitude, will be pushed over the air via the cell providers to active drones registered with a 4G/sim link before flight. Restrictions will be published on website as well. All pictures captured during flight will be uploaded to a database to be analyzed to ensure national security. Black out map data is written into the 4G drone link GPS module ram chip and encompasses a 5 mile radius around all airports, prisons, police stations, national monuments, national parks, etc.

By threshold break, the device is traceable with the links of ownership, and a flight log can be pulled by the FAA. For power supply the CMOS battery is added to keep the transponder/GPS locator active when the drone looses power and or crashes. This is also helpful to track rogue drone flights or active drones currently in the air.

The main advantage of the present invention is that it comes with a way to track ownership of a drone by adding a small receiver with the SIM card to a drone, so that when the drone crash or go missing it would be traceable by pinging the 4g data link that has an IP address, just like we can ping a lost phone. The device is linked to a deployable reusable parachute in case the drone falls back to earth at terminal velocity. Digital imaging and mapping could be uploaded to the 4G drone cloud that could be viewed by law enforcement/FBI/CIA, which is necessary to solve a case.

The commercial application of the device is that it could carry a payload, able to follow a shipping route, wirelessly rechargeable and all with the help of GPRS receiver for 4G data, (SIM) “Subscriber Identification Module”. a ram chip (random access memory), current GPS data MAP, and cloud storage to autonomously upload, store, and forward data.

It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations, or structures described herein as a single instance. Finally, boundaries between various components are somewhat arbitrary, and particular operations are illustrated in the context of specific illustrative configurations. Other allocations of functionality are envisioned, and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

I claim:

1. A system for tracking small unmanned aircraft flight operations, comprising:
a receiver,
a carrier,
an integrated circuit chip,
a ram chip,
a power supply source,
a navigation application,
receive the information regarding the geographic position for the small unmanned aircraft forwarded from the information extraction module of the control station;
translate the received information regarding the geographic position for the small unmanned aircraft to a format that is usable by one or more end users, and
transmit the translated information to the one or more end users for display.

2. The system of claim 1, wherein the receiver is a CDMA/GSM/GPS module for receiving GPS signals and for generating GPS location information.

3. The system of claim 1, wherein the source of power supply is CMOS (Complementary metal-oxide-semiconductor) battery.

4. The system of claim 1, wherein the carrier is 4G/3G/1G data connected to a standard mobile phone.

5. The system of claim 4, wherein the 4G carrier is used to map of shipping routes.

6. The system of claim 1, wherein the navigation application is integrated to the said carrier.

7. The system of claim 1, wherein the integrated circuit chip is subscriber identity module or subscriber identification module (SIM) card that is link to the 4G/3G/1G data carrier.

8. The system as claimed in claim 1, wherein said system is adapted to be used to continuously track and/or monitor objects.

9. A method for tracking small unmanned aircraft flight operations in real time, comprising:
applying a standard mobile phone;
connecting the mobile phone with an integrated circuit chip;
receiving digital data using receiver;
linking the carrier 4G/3G/1G data to the mobile phone;

10. The method for tracking small unmanned aircraft flight operations in real time as claimed in claim 9, wherein said receiver is a GPS receiver.
